(19) United States
(12) Patent Application Publication
(10) Pub. No.: US 2020/0013074 A1
(43) Pub. Date: Jan. 9, 2020

(54) DIGITAL MARKETING SYSTEM, INFORMATION PROCESSING APPARATUS, AND METHOD OF ASSISTING DIGITAL MARKETING

(71) Applicant: SHUN YOKOTA, KANAGAWA (JP)

(72) Inventor: SHUN YOKOTA, KANAGAWA (JP)

(73) Assignee: Ricoh Company, Ltd., Tokyo (JP)

(21) Appl. No.: 16/451,323

(22) Filed: Jun. 25, 2019

(30) Foreign Application Priority Data
Jul. 5, 2018 (JP) 2018-128462

(51) Int. Cl. G06Q 30/02; G06F 16/958; G06F 16/957

(52) U.S. Cl. CPC G06Q 30/0201; G06F 16/9577; G06Q 30/0202; G06F 16/958

(57) ABSTRACT

A digital marketing system, including a first service for performing a lead generation for attracting potential customers, and a second service for performing a lead nurturing for turning the potential customers into prospective customers, includes an information processing apparatus including circuitry, communicable with the first service and the second service via a network. The circuitry is configured to receive information on a purpose of digital marketing from a user terminal operated by a user, via the network, instruct the first service to create a home page based on the information on the purpose of digital marketing, receive, from the second service, marketing information applicable for marketing, the second service being configured to acquire the marketing information from the home page in response to browsing of the home page, and provide the marketing information to the user terminal.

### CROSS-REFERENCE TO RELATED APPLICATION

This application claims priority pursuant to 35 U.S.C. §119(a) to Japanese Patent Application No. 2018-128462, filed on Jul. 5, 2018 in the Japan Patent Office, the disclosure of which is incorporated by reference herein in its entirety.

### BACKGROUND

### Technical Field

This disclosure relates to a digital marketing system, an information processing apparatus, and a method of assisting digital marketing.

### Background Art

Marketing using mass media, such as television, radio, magazines and train advertisement, has been used to attract customers, and then digital marketing using digital channels has been growing. The digital marketing uses available digital channels, such as Web sites, e-mail, social networking, smartphone applications, and Internet of Things (IoT), to make effective promotion measures and to visualize customer data for implementing the marketing.

The digital marketing used for targeting consumer markets (Business-to-Consumer) applies promotion measures to inform products to consumers and to guide the consumers to purchasing of products while the digital marketing used for targeting business companies (Business-to-Business) applies a lead generation as an important measure. The lead generation indicates marketing activities used for attracting potential customers, such as the marketing to increase the number of inquiries using digital channels, such as web sites. Typically, a company performs the lead generation by creating a web site of the company to acquire customer information via the web site. In B-to-B, business activities start after performing a lead nurturing, such as extracting and approaching prospective customers. Typically, a company performs the lead nurturing that transmits direct mails to the prospective customers.

Various tools for assisting the digital marketing are available, in which users can implement measures by utilizing the content management system (CMS) tool, which assists the lead generation, and the marketing automation (MA) tool, which assists the lead nurturing. The CMS tool includes, for example, a tool for assisting a creation of Web site, and the MA tool includes, for example, a tool for analyzing an access to the web site.

### SUMMARY

As one aspect of the present invention, a digital marketing system including a first service for performing a lead generation for attracting potential customers, and a second service for performing a lead nurturing for turning the potential customers into prospective customers is devised. The digital marketing system includes an information processing apparatus including circuitry, communicable with the first service and the second service via a network. The circuitry configured to receive information on a purpose of digital marketing from a user terminal operated by a user, via the network; instruct the first service to create a home page based on the information on the purpose of digital marketing; receive, from the second service, marketing information applicable for marketing, the second service being configured to acquire the marketing information from the home page in response to browsing of the home page; and provide the marketing information to the user terminal.

As another aspect of the present invention, an information processing apparatus communicable with a first service for performing a lead generation for attracting potential customers, and a second service for performing a lead nurturing for turning the potential customers into prospective customers via a network is devised. The information processing apparatus includes circuitry configured to receive information on a purpose of digital marketing from a user terminal operated by a user, connected to the information processing apparatus via the network; instruct the first service to create a home page based on the information on the purpose of digital marketing; receive, from the second service, marketing information applicable for marketing, the second service being configured to acquire the marketing information from the home page in response to browsing of the home page; and provide the marketing information to the user terminal.

As another aspect of the present invention a method of assisting digital marketing using an information processing apparatus communicable with a first service for performing a lead generation for attracting potential customers, and a second service for performing a lead nurturing for turning the potential customers into prospective customers via a network is devised. The method includes receiving information on a purpose of digital marketing from a user terminal operated by a user, connected to the information processing apparatus via the network; instructing the first service to create a home page based on the information on the purpose of digital marketing; receiving, from the second service, marketing information applicable for marketing, the second service being configured to acquire the marketing information from the home page in response to browsing of the home page; and providing the marketing information to the user terminal.

### BRIEF DESCRIPTION OF THE DRAWINGS

A more complete appreciation of the description and many of the attendant advantages and features thereof can be readily acquired and understood from the following detailed description with reference to the accompanying drawings, wherein:

FIG. 1 is an example of a diagram illustrating a scheme of conventional digital marketing using various tools;

FIG. 2 is an example of a diagram illustrating a scheme of a digital marketing (DM) system according to an embodiment of the present embodiment;

FIGS. 3A, 3B, 3C and 3D are an example of a diagram illustrating a configuration of the DM system and processing in the DM system in a time series;

FIG. 4 is an example of a system configuration of the DM system;

FIG. 5 is an example of a hardware block diagram of a computer system;

FIG. 6 is an example of a functional block diagram illustrating functions of an assistance server, a content management system (CMS) server, a marketing automation (MA) server, and a user terminal;

FIGS. 7A to 7D are examples of screens, provided by a consulting unit of an assistance server, used for inputting what measure a user wants to implement using the digital marketing;

FIG. 8 is an example of a consulting result output by a consulting unit;

FIGS. 9A and 9B are examples of wizard screens, provided by a consulting unit of an assistance server, used for inputting what measure a user wants to implement using the digital marketing;

FIG. 10 illustrates examples of a parameter conversion database (DB);

FIG. 11 is an example of a content determination screen displayed by a consulting unit on a display device of a user terminal when a wizard screen is completed;

FIG. 12 is one example of a template screen used as a home page (HP) template;

FIG. 13 is another example of a template screen, created from HP template creation parameters and used as a HP template;

FIGS. 14A and 14B are examples of different types of inquiry forms;

FIGS. 15A and 15B are examples of embedding a transmission destination mail address and MA identification information into an HP template;

FIG. 16 is an example of MA tag written in a script language;

FIGS. 17A and 17B are examples of browsing-related information that is transmitted by executing MA tag;

FIG. 18 is an example of an MA information screen displayed on a display device when a user terminal communicates with an assistance server; and

FIG. 19 is an example of a sequence diagram illustrating a procedure from automatic consulting to browsing of MA information.

The accompanying drawings are intended to depict embodiments of the present invention and should not be interpreted to limit the scope thereof. The accompanying drawings are not to be considered as drawn to scale unless explicitly noted.

### DETAILED DESCRIPTION

A description is now given of exemplary embodiments of the present inventions. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present inventions.

In addition, it should be noted that the terminology used herein is for the purpose of describing particular embodiments only and is not intended to be limiting of the present inventions. Thus, for example, as used herein, the singular forms “a”, “an” and “the” are intended to include the plural forms as well, unless the context clearly indicates otherwise. Moreover, the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Hereinafter, a description is given of a digital marketing system and a marketing assistance method performed for the digital marketing system of one or more embodiments of the present invention. In the following description, the digital marketing system may be abbreviated as the DM system or DMS.

As to conventional technologies, a technology for automatically creating a web site by inputting information required for a template by users is known. Further, a technology for transmitting direct mail is known. Further, a technology providing an inquiry form on a home page and acquire customer information from the home page is known.

However, in conventional systems, the tools used for the digital marketing have been provided separately, which is not convenient. For example, even if the CMS tool and the MA tool exist, users need to select appropriate tools depending on the purpose of users, and even after the selection of tools, the users further need to coordinate the MA tool and the CMS tool (e.g., home page). However, it is not easy for the users not familiar with the digital marketing technology to perform such coordination work.

Issue on Tool Utilization:

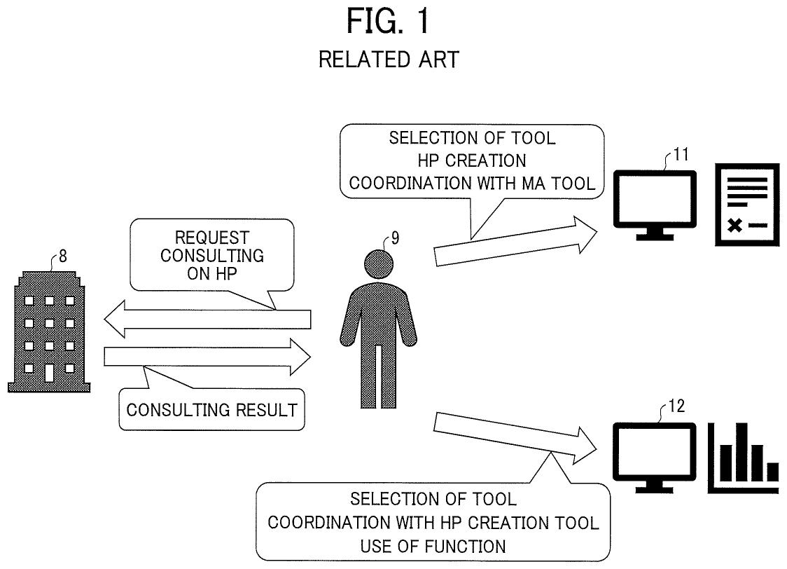

Hereinafter, a description is given of an issue on conventional digital marketing with reference to FIG. 1. FIG. 1 is an example of a diagram illustrating a scheme of conventional digital marketing using various tools.

Typically, a user 9 has a specific purpose that he or she wants to do using the digital marketing. For example, the user 9 may “want to make a home page (HP) for promoting a new product (product promotion)” or “want to transmit emails to potential customers.” However, the user 9 may not have knowledge or knowhow how to use the digital marketing, such as how to create an effective HP and how to transmit e-mails to potential customers (e.g., HP browsing persons) effectively.

Therefore, the user 9 consults a consultant of a consulting company 8 and acquires consulting results (advice) on what kind of HP is to be created for the specific purpose of the user 9. In this case, the user 9 needs to select a content management system (CMS) tool 11 and a marketing automation (MA) tool 12 based on the consulting results, from many candidate tools. Further, even if the CMS tool 11 and the MA tool 12 are selected by the user 9, the user 9 further needs to select and set appropriate functions matched to the specific purpose of the user 9 from each tool. For example, although the MA tool 12 can work effectively with the CMS tool 11 in coordination with the CMS tool 11, it is not easy for the user 9 to coordinate the MA tool 12 and the CMS tool 11.

### Embodiment

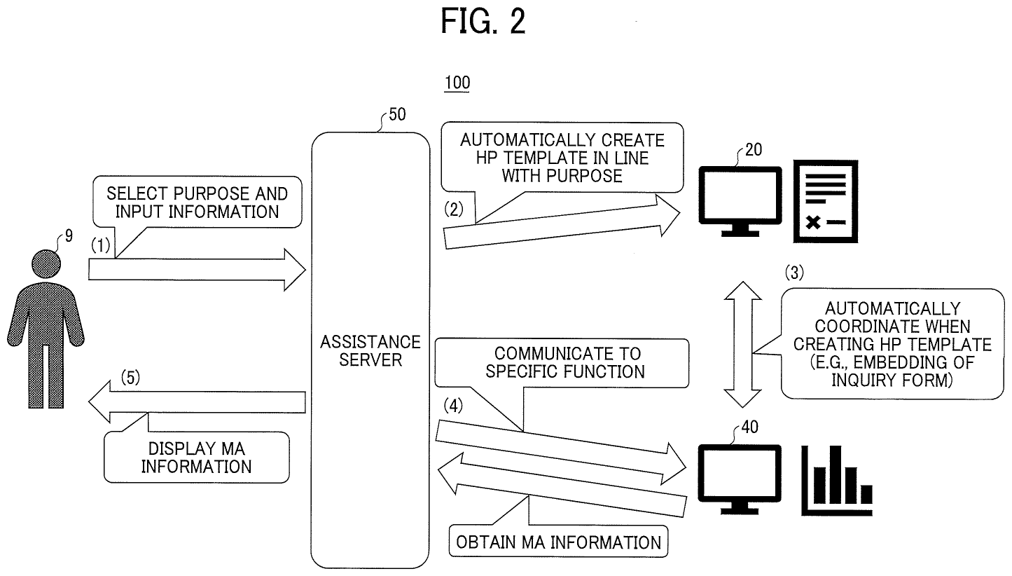

Hereinafter, a description is given of a scheme of a DM system 100 according to the present embodiment with reference to FIG. 2. As illustrated in FIG. 2, the DM system 100 includes, for example, an assistance server 50, with which the user 9 can utilize a CMS tool and a MA tool without being aware of the existence of the CMS tool and the MA tool. In this description, a server providing the CMS tool is referred to as a CMS server 20, and a server providing the MA tool is referred to as a MA server 40. Further, the user 9 is a user of the DM system 100 and also a user of the assistance server 50. Further, the user 9 is also a user of the CMS server 20 and the MA server 40 indirectly.

(1) At first, the user 9 inputs a purpose of the user 9, such as what measure the user 9 wants to implement using the digital marketing to the assistance server 50.

(2) The assistance server 50 performs automatic consulting processing for the purpose and causes the CMS server 20 to create an HP template matched to a result of the automatic consulting processing.

(3) The HP template describes specific processing used for coordinating the CMS tool and MA tool, and under the coordination with the CMS tool, the MA tool can acquire MA information (an example of marketing information), such as browsing state of HP and inquiry content of HP, from the CMS tool.

(4) The assistance server 50 communicates with the MA tool as needed to acquire or obtain the MA information.

(5) Then, if the user 9 accesses the assistance server 50, the user 9 can see or check the MA information.

As above described, by using the automatic consulting function via the assistance server 50 having a purpose-based interface for the user 9, the creation of HP template in accordance with the purpose of the user 9 and the coordination between the CMS tool and the MA tool can be implemented efficiently and effectively. The user 9 can achieve the desired measure using the digital marketing without directly selecting the CMS tool and MA tool individually and/or selecting the functions individually by himself or herself. By accessing the assistance server 50, the user 9 can reduce a burden of operating the respective tools used for the digital marketing. For example, the user 9 is not required to directly implement the contents acquired from the consultant using the CMS tool and MA tool.

Terms:

The lead generation is a process of acquiring new customers, such as attracting potential customers or latent customers. For example, the lead generation is an activity that is performed for acquiring potential customers. The lead generation is used to acquire personal information of individuals or companies that have interest in goods products or services (hereinafter, collectively referred to as product) provided by a vendor, rather than unspecified large number of persons. In a broader sense, the lead generation includes activities not using HP (or web site), but in the embodiment, the lead generation refers to activities that mainly utilize the HP.

The lead nurturing is a process of turning or converting the acquired potential customers into prospective customers. For example, the lead nurturing is an activity to nurture and educate a potential customer to a prospective customer (e.g., paying customer) as a target of making a contract and receiving an order. For example, the lead nurturing is an activity to build relationships with the potential customers acquired by the lead generation as the prospective customers using mail magazines or the like so that the prospective customers become actual customers for sales opportunity and business opportunities.

Information on purpose of the digital marketing is the intent of a user that he or she wants to do with the digital marketing. The information on purpose of the digital marketing may not necessarily be written but may include one or more measures that are retained unconsciously.

The HP is a screen presented by the world wide web (WWW) system, which is used for the Internet. The HP may include not only the first page to be displayed by a terminal apparatus, but also all pages which can be displayed by the terminal apparatus.

The HP is also referred to as a web site or web page, and it is not strictly distinguished in the embodiment.

The marketing information useful or applicable for marketing goods and services (i.e., product) can be any information acquired by browsing the HP by a person. The marketing information also includes information entered or input by the person that browses the HP. The marketing information also includes information processed by the HP (for example, the number of viewing persons) based on the operation of HP browsing, such as information processed by a server running the HP and information that the server has acquired from the HP.

Scheme of Operation of DM System:

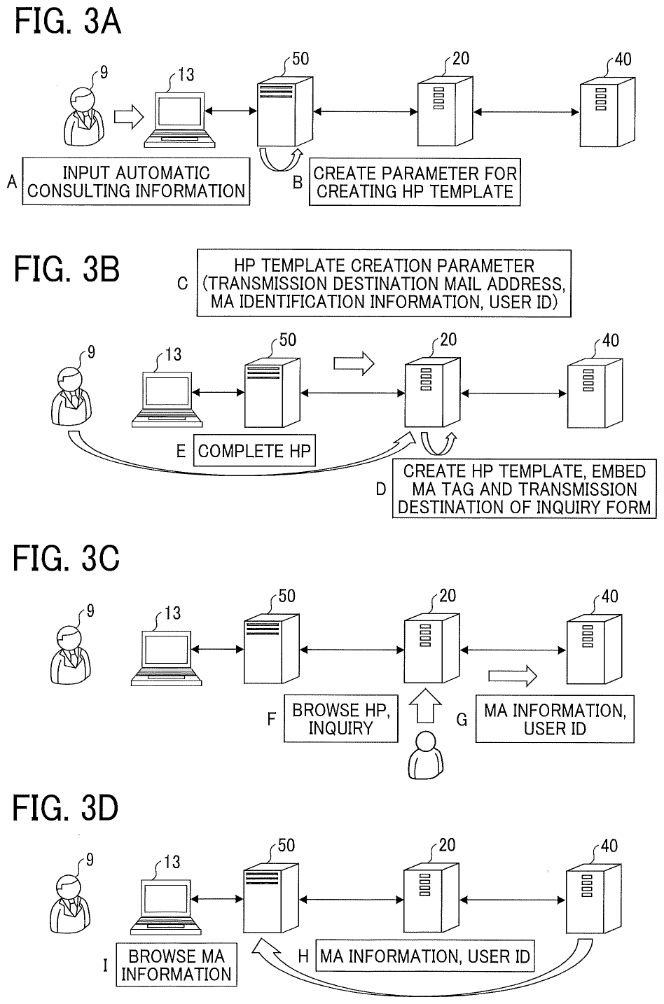

Hereinafter, a description is given of a scheme of operation of the DM system 100 with reference to FIGS. 3A to 3D. FIGS. 3A to 3D illustrate an example of a diagram illustrating a configuration of the DM system 100 and processing in the DM system 100 in a time series. As illustrated in FIG. 3, the DM system 100 includes, for example, a user terminal 13, the assistance server 50, the CMS server 20, and the MA server 40. Since the user 9 can use the CMS tool provided by the CMS server 20 and the MA tool provided by the MA server 40 via the assistance server 50, the assistance server 50 can provide one stop service of the CMS server 20 and the MA server 40 to the user 9.

FIGS. 3A to 3D illustrate a process of coordinating the CMS server 20 and the MA server 40 when the user 9 accesses the assistance server 50 using the user terminal 13, and the process includes steps indicated as “A” to “I” in FIGS. 3A to 3D.

A: The user 9 inputs a purpose (hereinafter, referred to as “automatic consulting information”) to the user terminal 13, wherein the purpose indicates a measure that the user 9 wants to perform using the digital marketing.

B: The assistance server 50 prepares the knowledge of converting the automatic consulting information into the content suitable for achieving the purpose of the user 9 based on the automatic consulting information, and creates parameters for creating a HP template (hereinafter, HP template creation parameter means one or more parameters for creating the HP template) from the automatic consulting information. The HP template creation parameter includes one or more contents to be included in the HP that are effective for achieving the purpose of the user 9. In this description, the HP template creation parameter is described as one or more template creation parameters used for creating any template.

C: The assistance server 50 transmits the HP template creation parameter to the CMS server 20. When transmitting the HP template creation parameter to the CMS server 20, the assistance server 50 transmits a transmission destination mail address (destination of inquiry content), MA identification information (information identifying the MA server 40 to be coordinated with the CMS server 20) and user ID (user ID is information identifying MA information related to the user 9 at a later stage).

D: The CMS server 20 creates an HP template based on the HP template creation parameter. As above described, since the HP template creation parameter indicates the contents that the HP is required to include, the CMS server 20 can create the HP template matched to the contents. For example, if the actual product introduction material is the contents, an HP template used for describing customer's photo, customer comments, and product introduced to customer is created.

Further, the CMS server 20 embeds an MA tag and a transmission destination of the inquiry form in the HP template. The MA tag and the transmission destination of the inquiry form can be described using, for example, hypertext markup language (HTML) tag and JavaScript (registered trademark), and can be used to transmit browsing-related information indicating a browsing history of the HP and the inquiry content, which are acquired from the HP when a person browses the HP, to the MA server 40. Hereinafter, the person that browses the HP may be referred to as the browsing person, the browsing-related information or browsing information indicates a browsing history of the HP by one or more persons (i.e., browsing persons), and the inquiry content includes one or more inquiry contents.

E: Since the HP template is just a template and actual contents are not yet set, the user 9 completes the HP in accordance with the HP template.

F: When the HP is completed and posted to the public, a browsing person can browse the HP. If the browsing person needs more information, the browsing person enters the inquiry content, such as a corporate name and mail address, using the inquiry form. If the browsing person does not enter the name of the corporation or company, a domain can be identified from an IP address of the browsing person, and a name of the company can be identified from the domain.

G: The CMS server 20 transmits MA information (browsing-related information and inquiry content) to the MA server 40. The MA server 40 is designated by the MA identification information set in the above “C.” In addition, the CMS server 20 transmits the user ID with the MA information. This process is performed to deliver the MA information acquired from the HP created by the user 9, to the user 9. Similarly, the MA information can be transmitted to the transmission destination mail address set in the above “C.”

H: The assistance server 50 acquires the MA information associated with the user ID from the MA server 40. The acquisition method can use a PULL method or a PUSH method.

I: The user 9 can browse, check or confirm the MA information by accessing the assistance server 50. Thus, by communicating with the assistance server 50 almost alone, the user 9 can perform the digital marketing using the CMS tool and the MA tool even if the user 9 is not familiar with the information technology (IT).

System Configuration:

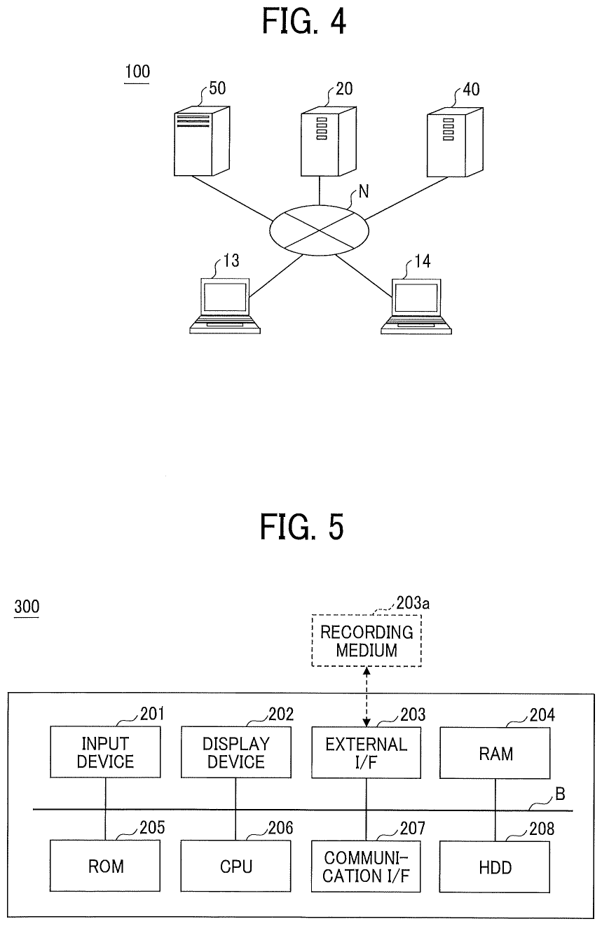

FIG. 4 is an example of a system configuration of the DM system 100. As illustrated in FIG. 4, the DM system 100 includes, for example, the assistance server 50, the CMS server 20, the MA server 40, the user terminal 13, and a viewer terminal 14 capable of communicating with each other via a network N. The assistance server 50, the CMS server 20, the MA server 40, the user terminal 13, and the viewer terminal 14 are not required to communicate constantly, but the communication can be performed as needed.

The network N is assumed to be a general network such as the Internet. The network N includes, for example, a local area network (LAN) within the company or a home, or a wide area network (WAN) comprising a wide area Ethernet (registered trademark) and a plurality of LANs. The network N can be partially or entirely wireless. The wireless network may include wireless LANs, worldwide interoperability for microwave access (WiMAX) and other mobile networks, such as 3G, 4G, 5G, and the like.

The assistance server 50, the CMS server 20 and the MA server 40 are servers having functions of the information processing apparatus. The server is a computer that provides files and data to other computers connected via a network. The server may be also referred to as a web server, an HTTP server, a WWW server, or the like. However, the assistance server 50, the CMS server 20 and the MA server 40 do not need to be dedicated server, but can be a general-purpose information processing apparatus.

The CMS server 20 is a server that performs or assists a lead generation (an example of first service) that attracts potential customers. For example, the CMS server 20 performs various processing, such as acquisition of customer information, acquisition of customer interest or preference information, and creation of a list of customers. Specifically, the CMS server 20 is a server that provides the HP creation tool that is used to create, update, and manage or control the HP (i.e., web site). In this configuration, the first service can be implemented by circuitry, software, or a combination of the circuitry and software, which can be disposed as a server.

The MA server 40 is a server that performs or assists the lead nurturing (an example of second service) used for turning or converting the potential customers into the prospective customers. For example, the MA server 40 performs various processing, such as mail delivery, sending printed mail, counting opening times, observation of other response actions, aggregation of responses, accuracy analysis, approach classification, approach determination, confirmation of accuracy, establishing business opportunity, initial visit, repeated visit, making proposal, and dealing a contract. In one example case, the MA server 40 provides a MA tool that performs an analysis of access to the HP. In this configuration, the second service can be implemented by circuitry, software, or a combination of the circuitry and software, which can be disposed as a server.

The CMS server 20 and the MA server 40 may not be separated servers, but can be one server that provides CMS tools and MA tools. In practice, there are a number of CMS servers 20 and MA servers 40, and the assistance server 50 can coordinate the respective CMS servers 20 and MA servers 40. When to determine which CMS server 20 or MA server 40 are to be used, there is a method that the assistance server 50 selects the CMS server 20 or MA server 40 based on the function and cost of CMS server 20 or MA server 40. If the user is not difficult or cumbersome to select the CMS server 20 or the MA server 40, the method can be designated by the user. The assistance server 50 can present an index (such as function, popularity level) that the user can select from the CMS server 20 or the MA server 40.

The user terminal 13 is a terminal apparatus used by the user 9, and is a general-purpose information processing apparatus having a communication function and a display function. The user terminal 13 can be the information processing apparatus, such as a personal computer (PC), a tablet terminal, a smartphone, a portable telephone, a wearable PC such as a clock type, or the like. In addition, an apparatus having a function of the information processing apparatus such as electronic blackboard, television conference terminal, digital signage terminal, navigation system, or the like can be used as the user terminal 13. The number of the user terminals 13 can be one or more.

The viewer terminal 14 is a terminal apparatus used by a person who browses the HP. The viewer terminal 14 is a general-purpose information processing apparatus having a communication function and a display function. For example, the configuration of the viewer terminal 14 can be the same as the user terminal 13. Further, it can be assumed that a plurality of viewer terminals 14 exists.

The browser software is operated on the user terminal 13 and the viewer terminal 14. The assistance server 50 transmits screen information to the user terminal 13. Further, since the CMS server 20 posts an HP using a HP posting server (HP server) to be described later, the HP posting server transmits the screen information of HP to the viewer terminal 14. In the configuration in FIG. 4, the CMS server 20 and the HP posting server (FIG. 69 are assumed to be one sever. The screen information can be described, for example, in HTML, script language (JavaScript: registered trademark), and cascade style sheet (CSS). The screen information may be also referred to as a web page or a web application. The web application can be operated by executing the script language (e.g. JavaScript (registered trademark)) and the software program at the web server together, and the web application means software or procedures used by the browser software. It should be noted that the user terminal 13 and the viewer terminal 14 can use the application software having an equivalent function instead of the browser software.

Hardware Configuration:

Hereinafter, a description is given of hardware configurations of the assistance server 50, the CMS server 20, the MA server 40, the user terminal 13, and the viewer terminal 14 of the DM system 100 according to the present embodiment.

Hardware Configurations of Assistance server, CMS Server, MA Server, User Terminal, and Viewer Terminal:

The hardware configurations of the assistance server 50, the CMS server 20, the MA server 40, the user terminal 13 and the viewer terminal 14 can be implemented by, for example, using a computer system having a hardware configuration illustrated in FIG. 5. FIG. 5 is an example of a hardware block diagram of a computer system 300 according to the present embodiment.

As illustrated in FIG. 5, the computer system 300 includes, for example, an input device 201, a display device 202, an external interface (I/F) 203, a random-access memory (RAM) 204, a read only memory (ROM) 205, a central processing unit (CPU) 206, a communication interface (I/F) 207, and a hard disk drive (HDD) 208 connected to one another via a bus B.

The input device 201 includes, for example, a keyboard, a mouse, a touch panel and the like, and the user 9 uses the input device 201 to input each operation signal. The display device 202 includes, for example, a display to display processing results processed by the computer system 300.

The communication I/F 207 is an interface for connecting the computer system 300 to the internal network and the Internet, or the like. With this configuration, the computer system 300 can communicate with other system or apparatus via the communication I/F 207.

The HDD 208 is a nonvolatile storage device that stores programs and data. The stored programs and data include operating system (OS), which is the basic software that controls the computer system 300 entirely, and application software programs, which provide various functions on the operating system. The HDD 208 stores the programs and the data stored in the HDD 208 using a given file system and/or database (DB).

The external I/F 203 is an interface with an external device. The external device includes, for example, a recording medium 203a or the like. With this configuration, the computer system 300 can read and write information on the recording medium 203a via the external I/F 203. The recording medium 203a includes, for example, a flexible disk, compact disc (CD), digital versatile disk (DVD), secure digital (SD) memory card, universal serial bus (USB) memory card, or the like.

The ROM 205 is a non-volatile semiconductor memory (storage device) capable of retaining programs and data even when the power supply is turned off. The ROM 205 stores programs and data such as basic input/output system (BIOS), OS settings, and network settings to be executed at the time of activating the computer system 300. The RAM 204 is a volatile semiconductor memory (storage device) that temporarily retains the program and the data.

The CPU 206 is a computing device that reads programs and data from a storage device such as the ROM 205 and the HDD 208 onto the RAM 204 and implements the controlling and functions of the computer system 300 entirely.

It is preferable that the assistance server 50, the CMS server 20, and the MA server 40 are compatible to the cloud computing. The cloud computing indicates a use of resources on the network without knowing specific locations of the specific hardware resources.

Further, the input device 201 and the display device 202 of the assistance server 50, the CMS server 20 and the MA server 40 can be included in the computer system 300 as needed.

Function:

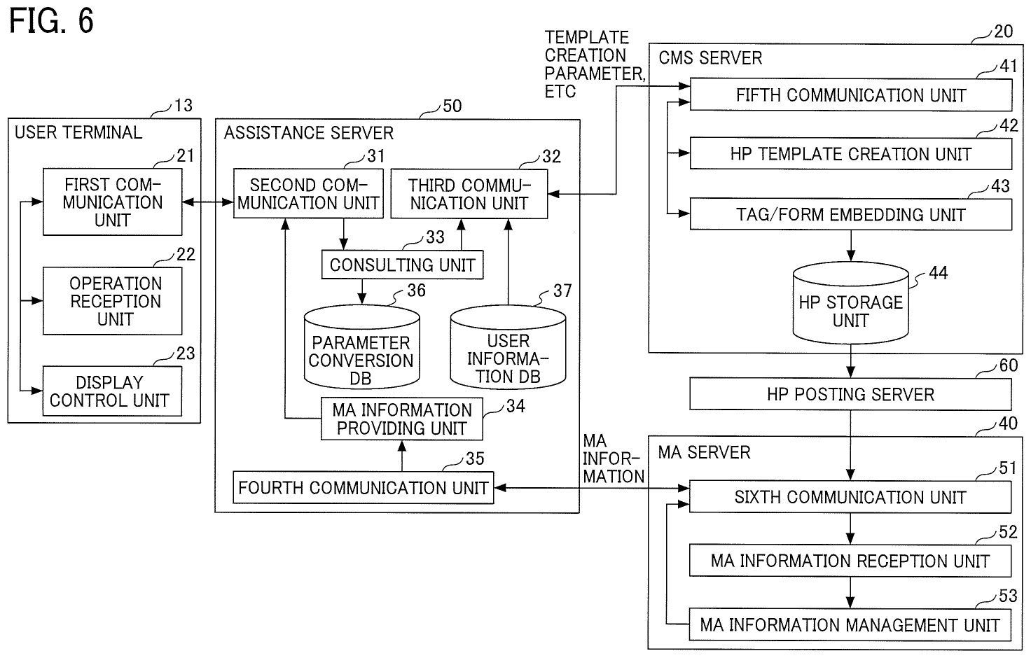

Hereinafter, a description is given of functions of the assistance server 50, the CMS server 20, the MA server 40, and the user terminal 13 with reference to FIG. 6. FIG. 6 is an example of a functional block diagram illustrating functions of the assistance server 50, the CMS server 20, the MA server 40 and the user terminal 13. It should be noted that the viewer terminal 14 has functions similar to those of the user terminal 13.

User Terminal:

As illustrated in FIG. 6, the user terminal 13 includes, for example, a first communication unit 21, an operation reception unit 22, and a display control unit 23. Each of the functions of the user terminal 13 is a function or means implemented by any one of the components illustrated in FIG. 5 under an instruction from the CPU 206 in accordance with one or more programs loaded on the RAM 204 and executed by the CPU 206. The programs can be distributed from a server used for program distribution or is distributed in a state stored in a storage medium.

The first communication unit 21 transmits and receives various kinds of information with the assistance server 50. In the embodiment, the first communication unit 21 transmits the automatic consulting information to the assistance server 50, and receives the MA information from the assistance server 50. However, the communication is not limited thereto. The first communication unit 21 transmits a request for acquiring the screen information from the assistance server 50, and transmits the information input to the screen by the user 9 to the assistance server 50 to transmit and receive various kinds of information with the assistance server 50. This communication function can be provided by a browser software program.

The display control unit 23 analyzes the screen information received by the first communication unit 21 and displays the screen information on the display device 202. That is, the display control unit 23 displays the HP (web page). Depending on the HP, the user 9 can input information in one or more input fields set on the HP, such as input field for inputting text data, radio buttons and check boxes for selecting items.

The operation reception unit 22 receives various operations input to the user terminal 13. For example, the operation reception unit 22 receives various inputs, instructions for receiving information, and instructions for information transmission to the HP.

Assistance Server:

As illustrated in FIG. 6, the assistance server 50 includes, for example, a second communication unit 31, a third communication unit 32, a consulting unit 33, an MA information providing unit 34, and a fourth communication unit 35. Each of the functions of the assistance server 50 is a function or means implemented by any one of the components illustrated in FIG. 5 under an instruction from the CPU 206 in accordance with one or more programs loaded on the RAM 204 and executed by the CPU 206. The programs can be distributed from a server used for program distribution or is distributed in a state stored in a storage medium.

The assistance server 50 also includes, for example, a parameter conversion database (DB) 36 and a user information database (DB) 37 stored by using the HDD 208 illustrated in FIG. 5. At first, the user information DB 37 is described. It should be noted that the parameter conversion DB 36 and the user information DB 37 can be stored in the assistance server 50, or on the network N.

| | |
|---|---|
| Company name | Sample Incorporation |
| USER ID | companyA |
| Password | **** |
| Transmission destination | suzuki.sample.co.jp |
| mail address of inquiry form | yamada.sample.co.jp |
| HP posted flag | True |
| Latest update date and | 2018/05/05/12:34 |
| time of MA information | |
| MA identification information | Masysytem.com/aaa |
| | https://example.com/hoge |

Table 1 schematically illustrates user information stored in the user information DB 37. Information on the user 9 is stored in the user information DB 37. For example, the information on the user 9 includes items, such as company name, user ID, password, transmission destination mail address of inquiry form, HP posted flag, latest update date and time of MA information, and MA identification information. The name of company is a name of a company of the user 9 that uses the DM system 100. The user ID is identification information for identifying or specifying the user 9. The ID is an abbreviation of identification, and the ID means identifier or identification information. The ID employs, for example, a name, a sign, a string of characters, a numerical value, or a combination of one or more of these for uniquely distinguishing a specific target from a plurality of targets. For example, an e-mail address can be used as the user ID.

The transmission destination mail address of inquiry form is an e-mail address to which inquiry content input by a person (browsing person) into the inquiry form embedded in the HP is transmitted. Accordingly, the transmission destination mail address of inquiry form is embedded in the HP, and the inquiry content entered or input into the inquiry form by a person (browsing person) is sent to the transmission destination mail address of inquiry form. Further, a plurality of mail addresses can be set for the transmission destination mail address of inquiry form. The HP posted flag is set to indicate whether or not the HP is posted. Since the MA information cannot be acquired if the HP is not posted to the public, the HP posted flag is sent from the CMS server 20 to the MA server 40 when acquiring the MA information. The latest update date and time of MA information is the date and time when the MA information was updated most recently. The latest update date and time of MA information can be used to acquire a difference between two or more pieces of the MA information.

The MA identification information corresponds to the identification information of the MA server 40 used by the user 9. As illustrated in Table 1, the relationship between the user 9 and the MA server 40 can be fixed, but the assistance server 50 can be configured to switch or change the relationship between the user 9 and the MA server 40 when a given period of time elapses. The MA identification information is embedded in the HP to transmit the inquiry content to MA server 40 and to transmit browsing-related information by the MA tag to MA server 40.

Hereinafter, a description is given of each of the functions of the assistance server 50. The second communication unit 31 communicates with the user terminal 13 to transmit and receive various kinds of information. That is, the second communication unit 31 transmits various screen information and the MA information to the user terminal 13, and receives the automatic consulting information from the user terminal 13.

The third communication unit 32 communicates with the CMS server 20 to transmit and receive various kinds of information. In the embodiment, the third communication unit 32 sends the HP template creation parameter to the CMS server 20. The HP template creation parameter is attached with the transmission destination mail address, the MA identification information and the user ID. The assistance server 50 can use an application program interface (API) of the CMS server 20. Further, in response to the creation of HP template, the third communication unit 32 receives the HP creation universal resource locator (URL).

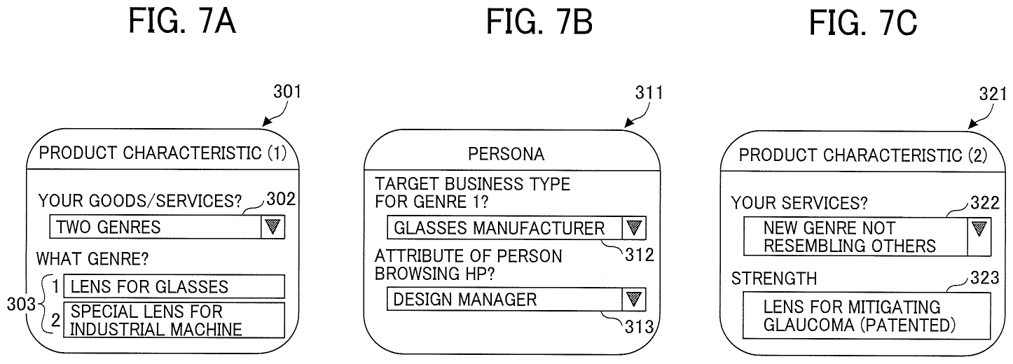

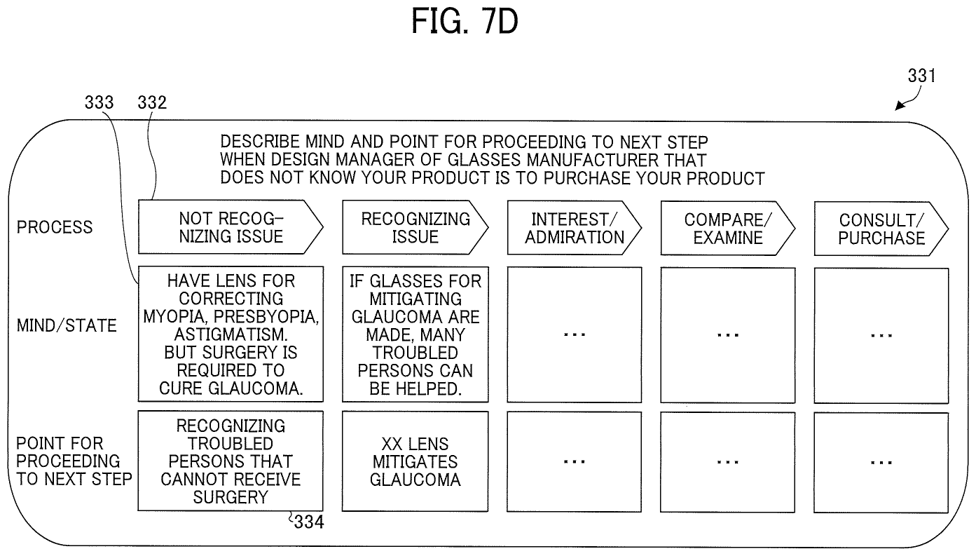

The consulting unit 33 creates the HP template creation parameter by referring to the parameter conversion DB 36 based on the automatic consulting information. The details of the consulting unit 33 will described with reference to FIGS. 7 to 11.

The fourth communication unit 35 communicates with the MA server 40 to transmit and receive various kinds of information. In the embodiment, the fourth communication unit 35 receives the MA information from the MA server 40. The fourth communication unit 35 can receive the MA information from the MA server 40 using PUSH communication. In this case using the PUSH communication, the MA server 40 recognizes the API of the assistance server 50 and transmits the MA information to the API of the assistance server 50.

Further, the fourth communication unit 35 can perform a PULL communication with the MA server 40 to request the MA information to the MA server 40 and to receive the MA information from the MA server 40 as a response to the request. In this case using the PULL communication, the assistance server 50 recognizes the API of the MA server 40 and requests the MA information to the API of the MA server 40.

Further, the fourth communication unit 35 can designate the update date and time of MA information, and acquire the MA information acquired by the MA server 40 later than the designated update date and time of MA information.

Further, since the MA information is associated with the user ID in the MA server 40, the fourth communication unit 35 can acquire the MA information for each of different users.

The MA information providing unit 34 provides the MA information associated with the user ID to the user terminal 13 via the second communication unit 31 in response to receiving the information request from the user terminal 13.

CMS Server:

As illustrated in FIG. 6, the CMS server 20 includes, for example, a fifth communication unit 41, an HP template creation unit 42, and a tag/form embedding unit 43. Each of the functions of the CMS server 20 is a function or means implemented by any one of the components illustrated in FIG. 5 under an instruction from the CPU 206 in accordance with one or more programs loaded on the RAM 204 and executed by the CPU 206. The programs can be distributed from a server used for program distribution or is distributed in a state stored in a storage medium.

The fifth communication unit 41 communicates with the assistance server 50 to transmit and receive various kinds of information. In the embodiment, the fifth communication unit 41 receives the HP template creation parameter, the transmission destination mail address, the MA identification information, and the user ID from the assistance server 50.

The HP template creation unit 42 creates an HP template using the HP template creation parameter. When the HP template is created, the HP template creation unit 42 creates, for example, a prototype of HP set with dummy contents instead of real contents.

The tag/form embedding unit 43 embeds the MA tag, the transmission destination mail address of inquiry form, and the MA identification information in the HP template. The embedding means describing the HTML tag or scripting language. The inquiry content can be sent to one of the transmission destination mail addresses and the MA identification information illustrated in Table 1 (e.g., Masysytem.com/aaa). Therefore, the inquiry form is embedded with at least one of the transmission destination mail address and the MA identification information.

The MA tag is a tag used by the HP posting server 60 to transmit the browsing-related information indicating a browsing history of the home page, such as the number of viewing persons (page view (PV) number) generated when the browsing persons views the HP, to the MA server 40. The browsing-related information is sent to one of the MA identification information (e.g., https://example.com/hoge). Therefore, the browsing-related information embeds one of the MA identification information for each page.

Further, the tag/form embedding unit 43 embeds one or more user IDs in the HP template so that the user terminal 13 can display the MA information (e.g., inquiry content and browsing-related information). For example, a user ID is embedded in each of the inquiry form and the MA tag.

Accordingly, the inquiry content is sent directly to the user 9 (user terminal 13) using the transmission destination mail address, and also sent to the MA server. The browsing-related information is sent to the MA server alone.

The HP template embedded with the tag and the form is stored in an HP storage unit 44. The HP template is stored in a given URL for each user 9. This URL is used as the HP creation URL. The user 9 acquires the HP template stored in the HP storage unit 44 using the HP creation URL and completes the HP.

The completed HP is sent to the HP posting server 60 and posted to the public using the HP posting server 60. It should be noted that the CMS server 20 can be used to post the HP.

MA Server:

As illustrated in FIG. 6, the MA server 40 includes, for example, a sixth communication unit 51, an MA information reception unit 52, and an MA information management unit 53. Each of the functions of the MA server 40 is a function or means implemented by any one of the components illustrated in FIG. 5 under an instruction from the CPU 206 in accordance with one or more programs loaded on the RAM 204 and executed by the CPU 206. The programs can be distributed from a server used for program distribution or is distributed in a state stored in a storage medium.

The sixth communication unit 51 communicates with the assistance server 50 and the HP posting server 60 to transmit and receive various kinds of information. At first, the sixth communication unit 51 receives the MA information from the HP posting server 60. Then, the sixth communication unit 51 transmits the MA information to the assistance server 50 via the API of the assistance server 50 or the API of the MA server 40.

When the browsing person browses the HP posted to the public by the HP posting server 60, the MA information reception unit 52 receives the browsing-related information transmitted using the MA tag from the HP posting server 60 via the sixth communication unit 51. Similarly, for example, the MA information reception unit 52 receives the inquiry content entered or input into the HP form by the browsing person from the HP posting server 60. That is, the MA information reception unit 52 receives the MA information (e.g., browsing-related information and inquiry content).

The MA information management unit 53 stores the MA information (e.g., browsing-related information, inquiry content) received by the MA information reception unit 52 in association with the user ID. With this configuration, the MA information management unit 53 (MA information control unit) can transmit the MA information corresponding to each of the user 9 to the assistance server 50 via the sixth communication unit 51.

Automatic Consulting:

In the DM system 100 according to the present embodiment, the assistance server 50 can perform the consulting, which has been performed by an experienced consulting firm in conventional scene. As to the DM system 100 according to the present embodiment, the user 9 may not need to consult with the consulting firm, and a workload to reflect the consulting results (advice) of the consulting firm into the HP may not be required for the user 9.

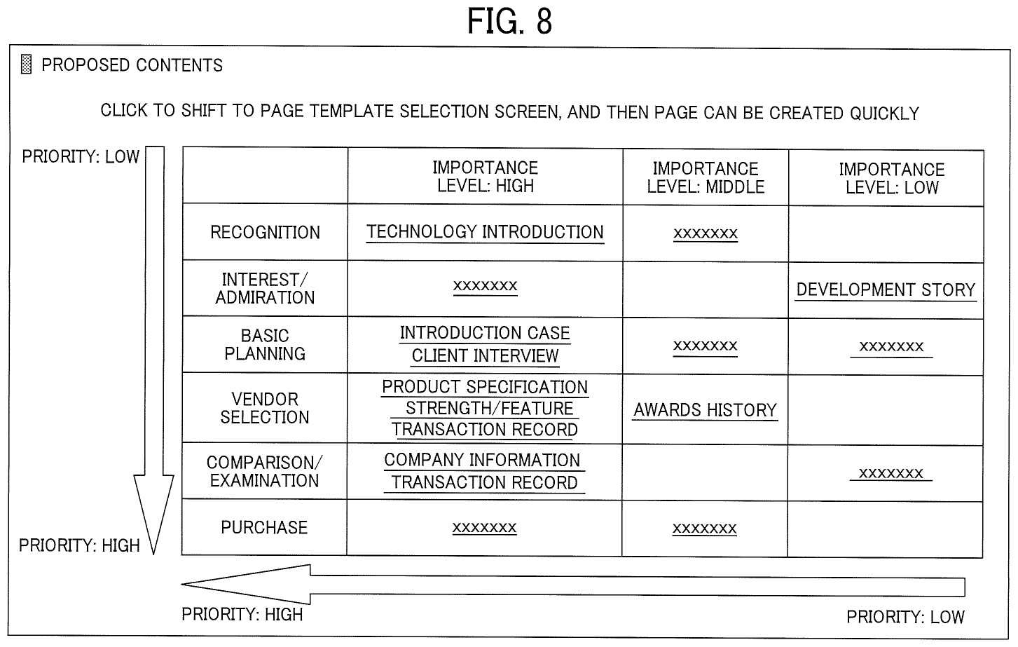

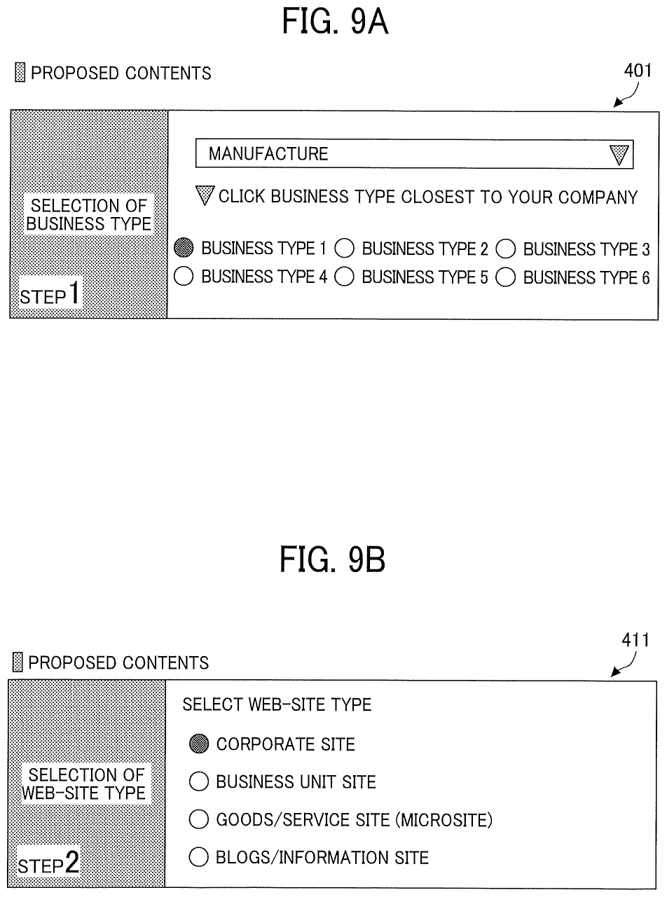

In the embodiment, the user 9 inputs the purpose of what kind of measure to be implemented using the digital marketing to the assistance server 50. The assistance server 50 has an interface compatible to receive an input corresponding to the purpose of the user 9. Hereinafter, one example case of the automatic consulting processing is to be described with reference to FIGS. 7 and 8, and another example case of the automatic consulting processing is to be described with reference to FIGS. 9 to 11.

FIGS. 7A to 7D are examples of screens, provided by the consulting unit 33 of the assistance server 50, used for inputting what measure the user 9 wants to implement using the digital marketing. FIGS. 7A to 7D illustrate the transition of screens in a time series.

FIG. 7A is a product characteristic input screen 301 in which an outline of goods or services (i.e., product) is input. The product characteristic input screen 301 includes, for example, a genre number selection field 302 and a genre input field 303. The genre number selection field 302 displays the number of genres of product (goods or services) handled by a company of the user 9 as selectable item. A specific genre of product (goods or services) is input in the genre input field 303.

FIG. 7B illustrates a target screen 311 in which an HP target is input for each genre. The target screen 311 includes, for example, a target business type field 312 and a target attribute field 313. The target business type field 312 displays a target business type, which is expected to purchase of the product (goods or services) as selectable item. The target attribute field 313 displays the attribute of customer (i.e., target person) that is expected to purchase the product (goods or services) as selectable item.

FIG. 7C illustrates a product detail screen 321 in which the details of product (goods or services) are entered or input. The product detail screen 321 includes, for example, a product characteristic field 322 and a feature field 323. The product characteristic field 322 displays the genre of the product (goods or services) as selectable item. The characteristic of the product (goods or services) is input to the feature field 323.

FIG. 7D illustrates a recognition process input screen 331 for inputting a process in which a product or a target person is recognized. The recognition process input screen 331 is used to input a target mind state 333 for each process 332 and a point 334 for proceeding to the next step. The recognition process input screen 331 is used to sequentially input the mind of the target person from a state that the target person that does not know the product (goods or services) of the user 9 to a state that the target person is to purchase the product (goods or services) of the user 9, and to input what is required to proceed to the next step.

The display control unit 23 sequentially shifts the screens illustrated in FIGS. 7A to 7D in accordance with the input of the user 9 to the operation reception unit 22. The information input in the screens illustrated in FIGS. 7A to 7D become the automatic consulting information. When the next screen information is required, the first communication unit 21 acquires the next screen information from the assistance server 50. Therefore, the user 9 can enter a vague purpose as specific sentences and numerical values in an interactive style by answering the query acquired from the assistance server 50. With this configuration, the user 9 can enter or input what purpose the user 9 wants to implement using the digital marketing.

The consulting unit 33 outputs a consulting result from the automatic consulting information. Conventionally, consultants derive consulting results from information such as automatic consulting information. A logic generated based on the knowledge acquired from the consultants is set in the parameter conversion DB 36 of the assistance server 50. Such logic can be constructed by machine learning or the like, or a flowchart of outputting consulting results from the automatic consulting information can be created by a developer.

FIG. 8 illustrates an example of a consulting result output by the consulting unit 33. In the embodiment, the consulting result becomes the HP template creation parameter for creating the HP. FIG. 8 illustrates an example of the HP template creation parameter in a matrix form.

First, the following items are listed along the vertical direction, such as recognition, interest/admiration, basic planning, vendor selection, comparison/examination, and purchase are listed along the vertical direction, in which the lower item has the higher priority order. The items and priorities can be determined by the automatic consulting processing. Further, the importance level is arranged from higher to lower from the left to right along the horizontal direction, in which the higher importance level means the higher priority.

The contents to be included in the HP template are set in view of the items on the vertical direction and the items on the horizontal direction. For example, the content having the highest importance in the recognition item is “Technical Information,” and the content having the highest importance in the comparison/examination is “Company Information/Transaction record.”

The HP template creation parameters illustrated in FIG. 8 are sent to the CMS server 20 from the assistance server 50. The assistance server 50 determines an HP template suitable for the contents. The contents and one or more HP templates cam be already associated with each other in the assistance server 50.

Further, the HP template creation parameter can be preferably displayed on the user terminal 13 before being sent to the CMS server 20. When the user 9 clicks on each content of FIG. 8 on the user terminal 13, the operation reception unit 22 receives the clicked content, and the first communication unit 21 transmits the clicked content to the assistance server 50. The assistance server 50 relays the clicked content to the CMS server 20, and the CMS server 20 determines one or more HP templates suitable for the clicked content and transmits the one or more HP templates to the assistance server 50. Then, the second communication unit 31 of the assistance server 50 transmits the HP template to the user terminal 13. With this configuration, the user 9 can select an HP template suitable for the content and quickly enter or input the content, such as photos and text. Then, the HP template input with the content is sent to the CMS server 20 via the assistance server 50. In this case, the CMS server 20 sets a higher priority on the HP template selected by user 9 and does not create an HP template suitable for the content.

Hereinafter, a description is given of another case of the automatic consulting processing with reference to FIGS. 9A and 9B. FIGS. 9A and 9B are examples of wizard screens provided by the consulting unit 33 of the assistance server 50. The wizard screen is used for inputting what measure the user 9 wants to implement using the digital marketing. The wizard screen illustrated in FIGS. 9A and 9B are completed when the user 9 answers the inquiry in the same manner as in FIGS. 7A to 7D, but the interactive operation can be improved compared to FIGS. 7A to 7D. The wizard is a processing style designed to display the information necessary for the user 9 (i.e., information assisting the user 9 to input information) so that the user 9 can easily operate in an interactive style.

FIG. 9A is an example of a business type selection screen 401. The user 9 selects a business type of product (goods or service) that is set as a target of the digital marketing. In FIG. 9A, business types 1 to 6 are displayed, but each specific business type can be confirmed by the user 9 or each specific business type can be confirmed by displaying a help screen. Further, the number of business types is not limited to six. FIG. 9B is an example of a web-site type selection screen 411. The user 9 can select what kind of web site is to be used to offer the product (goods or service) set as the target for the digital marketing. In FIG. 9B, “Corporate Site,” “Business Unit Site,” “Goods and Service Site (Microsite),” and “Blogs/Information Site” are listed as examples, but not limited thereto.

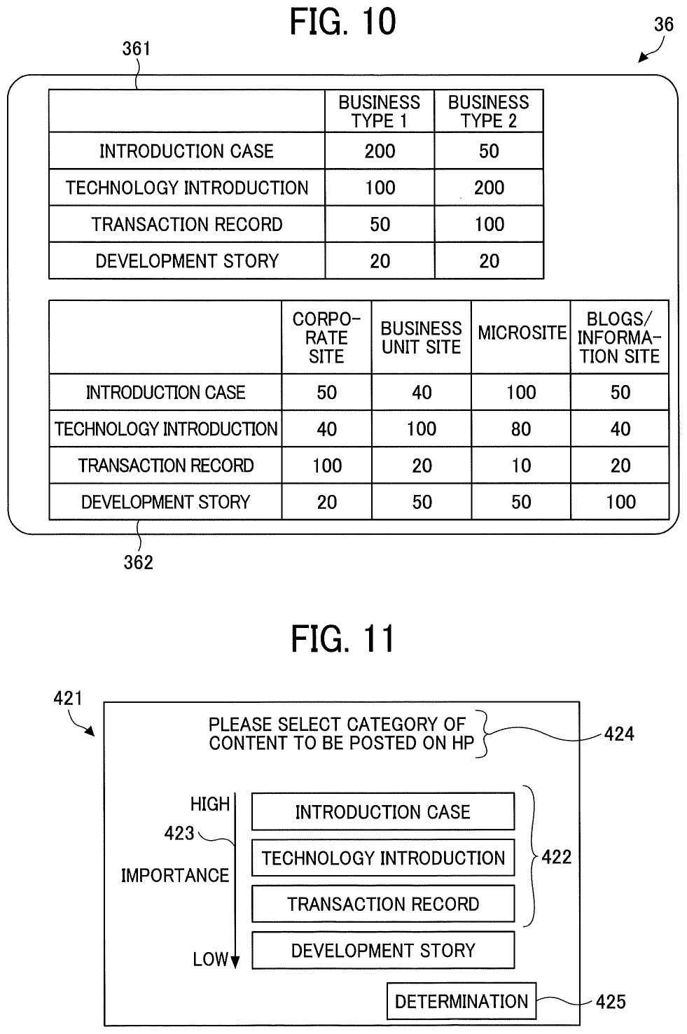

It can be considered that the content that is easily appealed to the browsing person may become different depending on the business type and web site type. Therefore, the consulting unit 33 converts the answer of the user 9 to the score of the category of each content using a parameter conversion DB 36 illustrated in FIG. 10.

FIG. 10 is an example of the parameter conversion DB 36. FIG. 10 includes an example of an association of the business type and the score of each content category 361, and an example of an association of the web site type and the score of each content category 362. If the user 9 selects “business type 1” in the business type selection screen 401 of FIG. 9A, the score of each content category becomes 200 for “Introduction Case,” 100 for “Technology Introduction,” 50 for the “Transaction Record,” and 20 for “Development Story.”

If the user 9 selects “Corporate Site” in the web-site type selection screen 411 of FIG. 9B, the score of each content category becomes 50 for “Introduction Case,” 40 for “Technology Introduction,” 100 for the “Transaction Record,” and 20 for “Development Story.”

Accordingly, if the user 9 selects “business type 1” in the business type selection screen 401 and selects “Corporate Site” in the web-site type selection screen 411, the score of each content category becomes as follows by adding the score of each content category.

| | |
|---|---|
| “Introduction Case” | 250 |
| “Technology Introduction” | 140 |
| “Transaction Record” | 150 |
| “Development Story” | 40 |

As above described, the consulting unit 33 repeats the process of converting the input purpose to the score based on the parameter conversion DB 36 every time the user 9 selects the content on the wizard screen. With this configuration, the scores of each content category can be determined in accordance with the respective selection. The relationship between the business type and the web site type registered in the parameter conversion DB 36 can be determined based on the consultant knowledge, or determined by machine learning or the like.

FIG. 11 is an example of a content determination screen 421 displayed by the consulting unit 33 on the display device 202 of the user terminal 13 when the wizard screen is completed. On the content determination screen 421, a message 424 of “Please select category of content to be posted on HP,” a content category 422, an importance bar 423 for each category, and a determination button 425 are displayed. Since the content category 422 is determined to be the higher importance as the score is higher, the higher importance category is displayed at the higher level of the importance bar 423.

The user 9 can select one or more categories to be used for the HP. For example, the user 9 can click one or more categories using a mouse, or tap a touch panel to select the one or more categories. The content category 422 of the selected content is highlighted using the higher luminance display or inverse luminance display style. If the user 9 presses the determination button 425 in this state illustrated in FIG. 11, the content category 422 of the selected content is sent to the assistance server 50 as the HP template creation parameter.

HP Template Created by CMS Server:

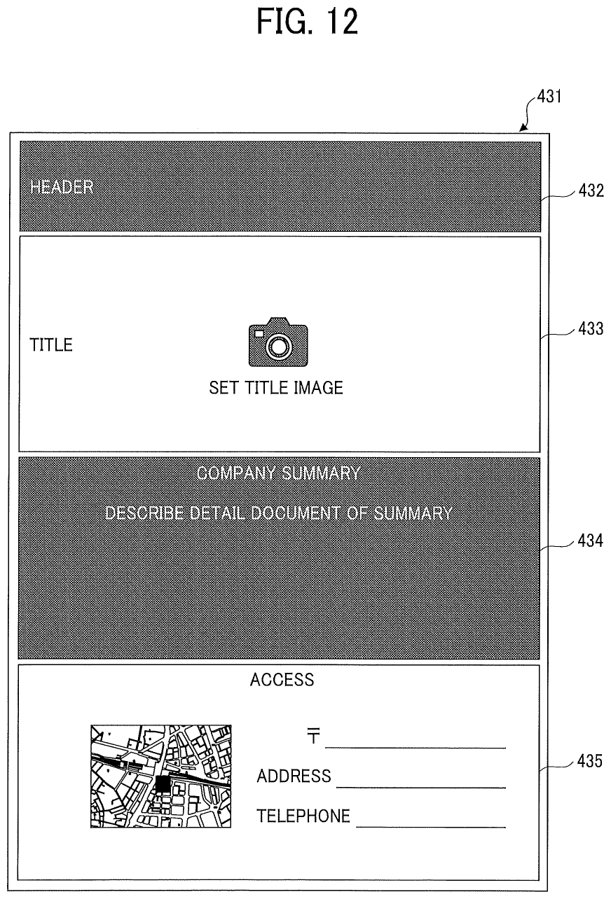

Hereinafter, a description is given of a HP template created from the HP template creation parameter with reference to FIG. 12. FIG. 12 is one example of a template screen used as the HP template. The template screen 431 (FIG. 12) includes contents, such as a header field 432, a title image field 433, a company outline field 434, and an access field 435 as an example of the HP template that can be commonly used regardless of the product (goods or services). These contents can be commonly used in any product (goods or services). The CMS server 20 can create the HP template, illustrated in FIG. 12, regardless of the HP template creation parameter. The user 9 can select color, position and size of the HP template, size of text, or the like, as needed. This is the same in the respective template screens.

When the template screen 431 (FIG. 12) is displayed on the user terminal 13, the user 9 inputs image and text into the header field 432, the title image field 433, the company outline field 434, and the access field 435, respectively. The operation reception unit 22 of the user terminal 13 receives these inputs, and then the HP template is completed. The first communication unit 21 transmits the HP template entered or input with the contents to the CMS server 20. In other words, the user terminal 13 can be configured to directly communicate with the CMS server 20 to complete the HP.

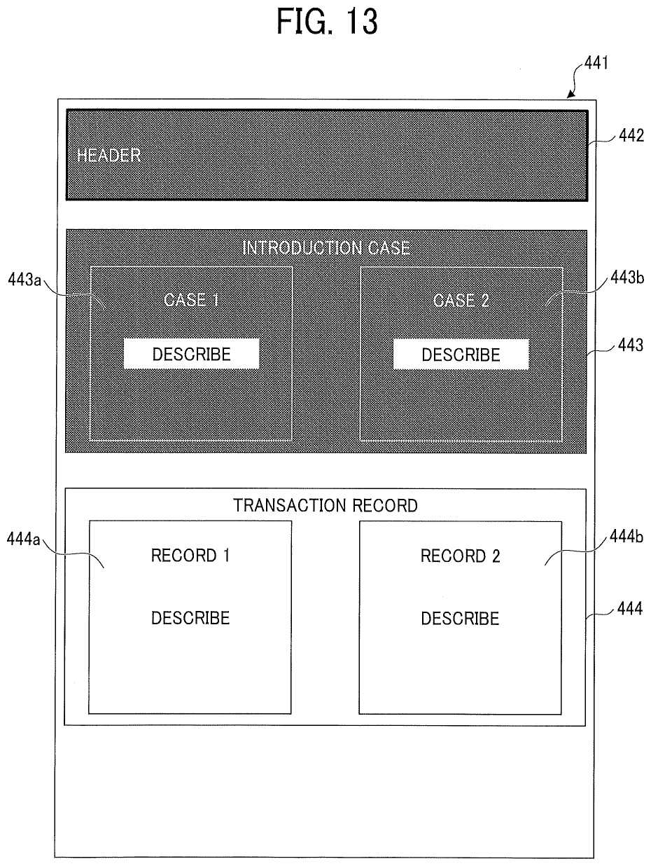

FIG. 13 is another example of a template screen 441, created from the HP template creation parameter and used as the HP template. The template screen 441 (FIG. 13) is an example of an HP template created from the HP template creation parameter determined by the automatic consulting processing. The template screen 441 includes, for example, a header field 442, an introduction case field 443, and a transaction record field 444. The CMS server 20 creates the HP template illustrated in FIG. 13 based on the HP template creation parameter. In other words, the user 9 selects the introduction case and the transaction record as the content category to be posted in the HP using the automatic consulting processing.

The introduction case field 443 further includes, for example, case input fields 443a and 443b, and the transaction record field 444 includes, for example, actual record input fields 444a and 444b. The user 9 inputs images and text to the introduction case field 443 and the transaction record field 444, respectively. Since the header field 442 is common to the one HP, it may not be necessary to input the header, but a different header can be entered or input. The operation reception unit 22 of the user terminal 13 receives these inputs, and then the HP template is completed. The first communication unit 21 transmits the HP template entered or input with the contents to the CMS server 20.

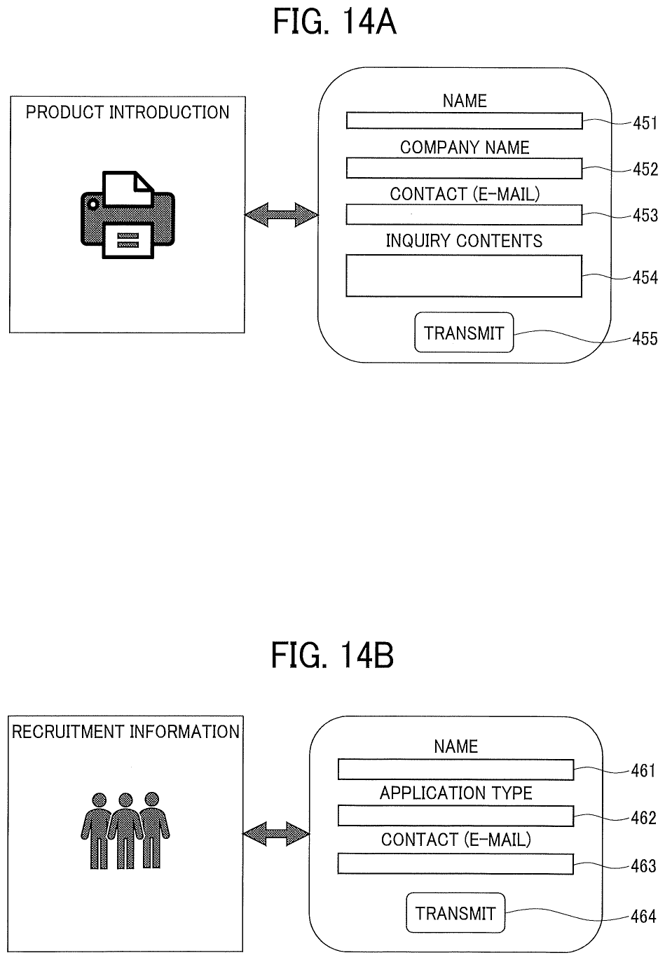

Hereinafter, a description is given of an inquiry form corresponding to the contents with reference to FIGS. 14A and 14B. The importance level of the inquiry form in the automatic consulting processing is often high. Further, the user 9 can also select the inquiry form as the content category. The inquiry form includes the form type suitable for the query contents. Accordingly, the HP template creation unit 42 sets the inquiry form corresponding to the HP template creation parameter, determined by the automatic consulting processing, to the HP template.

FIGS. 14A and 14B are examples of different types of inquiry forms. FIG. 14A is an example of the inquiry form for product introduction, and FIG. 14B is an example of the inquiry form for recruitment information.

As illustrated in FIG. 14A, the inquiry form for product introduction includes, for example, a name field 451, a company name field 452, a contact field 453, an inquiry content field 454, and a transmission button 455. As illustrated in FIG. 14B, the inquiry form for recruitment information includes, for example, a name field 461, an application type field 462, a contact field 463, and a transmission button 464. Thus, the HP template creation unit 42 automatically generates the inquiry form according to the category of content determined by the automatic consulting processing, and sets the inquiry form in the HP template.

Accordingly, even if various inquiry forms, such as the inquiry form for product introduction and the inquiry form for recruitment information, are to be created, the user 9 may not need to modify or change the inquiry form by himself or herself, and can use the HP template embedded with the inquiry form that is suitable for the content of the inquiry form.

HP Template Code:

A browsing person enters the inquiry content into the inquiry form illustrated in FIGS. 14A and 14B. In a case of FIG. 14A, a name is entered or input in the name field 451, a company name is entered or input in the company name field 452, and contact information is entered or input in the contact field 453, and an inquiry content is entered or input in the inquiry content field 454. In a case of FIG. 14B, a name is entered or input in the name field 461, an application type is entered or input in the application type field 462, and contact information is entered or input in the contact field 463. The input inquiry content must be communicated to a person in charge and a department of the company to which the user 9 belongs.

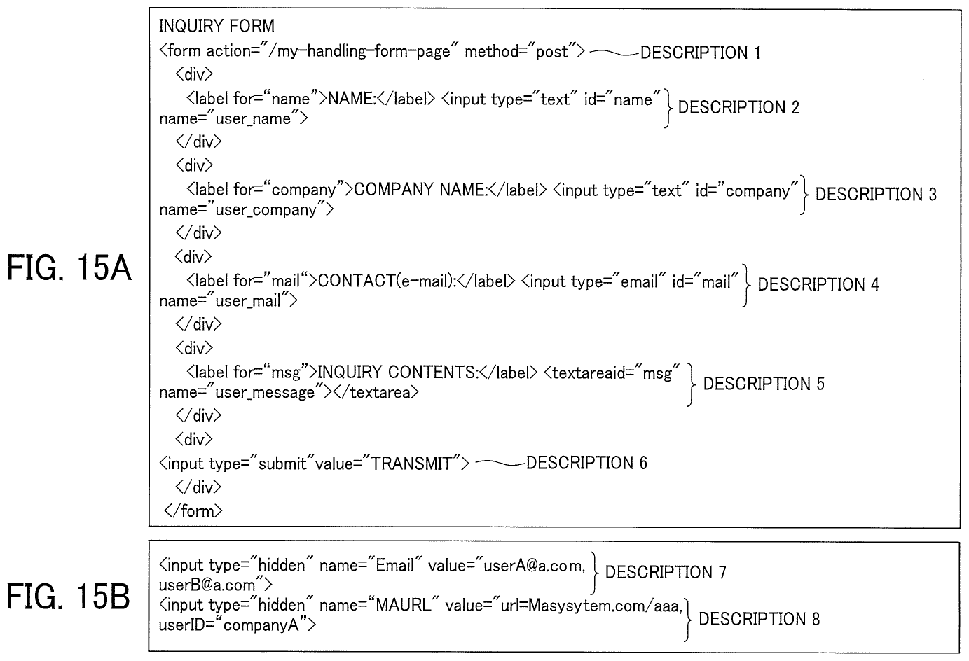

Hereinafter, a description is given of an example of embedding the transmission destination address to be used by the HP posting server 60 for transmitting the input inquiry content and the MA identification information to be used for transmitting the information to the MA server 40. FIGS. 15A and 15B are examples of embedding the transmission destination mail address and the MA identification information in the HP template.

FIG. 15A is an example of a code of the HP template related to the inquiry form. FIG. 15A is an example of code for the inquiry form of FIG. 14A, which is described in HTML. At first, a form tag is specified in description 1. The form tag is a tag used for transmitting a value entered or input by a form part piece such as an input tag, to the transmission destination specified by an action attribute. The transmission destination of description 1 is “/my-handing-form-page.” The method attribute specifies a HTTP method to be used when transmitting the inquiry content. The method attribute usually specifies “post” or “get.”

Description 2 is a code that implements the name field 451, and specifies that a label tag is used to display “name,” and specifies that the input tag is used to display a text entry field based on a type attribute. The “id” attribute is identification information for data processing and is specified when the script language and Cascade Style Sheet (CSS) are referred to. The name attribute is identification information of the name field sent together with the inquiry content, but the name attribute is also used to identify a person. Descriptions 3 to 5 are similarly codes that implement the company name field 452, the contact field 453, and the inquiry content field 454, respectively.

Description 6 specifies that the transmission button 455 is displayed. The type attribute specifies a transmission (i.e., submit), and the value attribute specifies text to be displayed.

As to the example codes indicated in FIG. 15A, when the browsing person inputs the inquiry content into the inquiry form and presses the transmission button 455, the inquiry content input to the inquiry form is sent to “/my-handing-form-page.” This description is referred to as a relative URL style, and the inquiry content are sent to the URL of the HP posting server 60 defined by “/my-handling-form-page.”

In the embodiment, since at least either the user 9 or the MA server 40 requires the inquiry content, <INPUT> tag illustrated in FIG. 15B is used. With this configuration, any transmission destination can be specified. The <INPUT> tag is, for example, an HTML tag.

The tag/form embedding unit 43 embeds the code as illustrated in FIG. 15B. The embedding portion is set, for example, in <form>-</form>, and can be set just before </form>tag. FIG. 15B illustrates an <INPUT> tag used for transmitting the inquiry content to the user 9 and an <INPUT> tag used for transmitting the inquiry content to the MA server 40.

In FIG. 15B, descriptions 7 and 8 are both the input tags. Since the type attribute is hidden for descriptions 7 and 8, the input tags do not appear in the inquiry form. The name attribute is the same as above. The value attribute indicates the transmission destination of the inquiry content. In description 7 (an example of second tag), the transmission destination mail address (userA@a.com, userB@a.com) setting the users as the transmission destination is embedded. In description 8 (an example of second tag), the MA identification information (Masysytem.com/aaa) setting the MA server 40 as the transmission destination is embedded. Both of the information are the transmission destinations of the inquiry content.

Further, the value attribute in description 8 has a description of “userID=“companyA.” The description of “userID=”companyA” is a user ID indicating the company to which the user 9 belongs. That is, when the inquiry content is sent, the identification information of the company to which the user 9 belongs is sent to the MA server 40, with which the MA server 40 can determine which company is the transmission destination of the inquiry content. The tag/form embedding unit 43 embeds the user ID together with the MA identification information in the HP template.

As above described, the tag/form embedding unit 43 of the CMS server 20 embeds, in the HP template, the HTML tags, to be used by the HP posting server 60 when to transmit the inquiry content to the userA@a.com and userB@a.com using the e-mail and to transmit the MA information of company A to the MA server 40 having “Masysytem.com/aaa” address.

The transmission destination mail address (userA@a.com, userB@a.com), user ID (userID=“companyA”) and the identification information (Masysytem.com/aaa) of the MA server 40 are sent to the CMS server 20 from the assistance server 50. These information can be automatically selected when the user 9 logs in the assistance server 50. That is, it can be assumed that the user 9 sets these information in the assistance server 50 in advance. However, the user 9 can optionally change one or more of the transmission destination information, the user ID, and the identification information of the MA server 40. For example, if there are two or more of CMS servers 20 and two or more of MA servers 40, the user 9 can select the desired CMS server 20 and the MA server 40. In this case, the tag/form embedding unit 43 embeds the identification information of the MA server 40 selected by the user 9 in the HP template.

In FIG. 15, the transmission destination mail address, the user ID, and the identification information of the MA server 40 are embedded using the HTML tag, but these information can be embedded using JavaScript (registered trademark).

MA Tag:

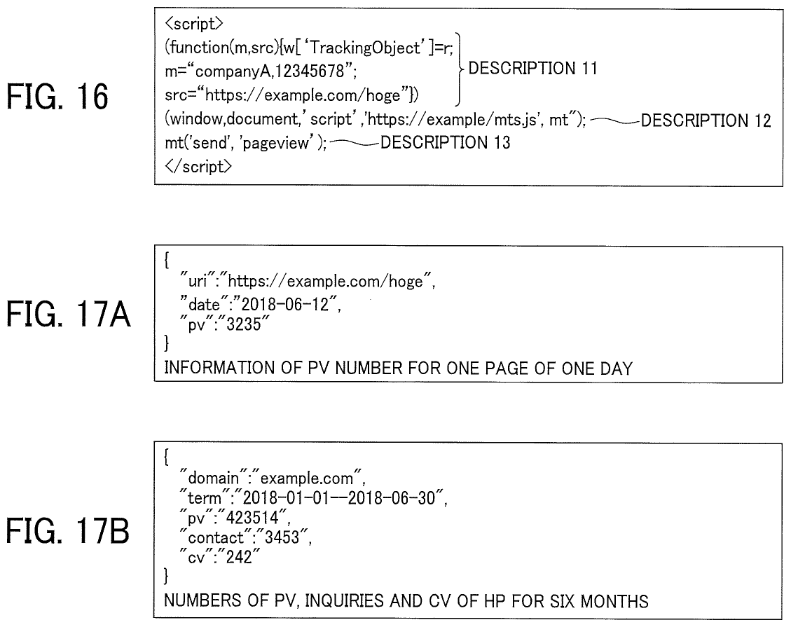

Hereinafter, a description is given of the MA tag with reference to FIG. 16. FIG. 16 is an example of the MA tag written in a script language. The MA tag (an example of first tag) is a tag used for transmitting the page view (PV) number to the MA server 40. In description 11, “m=“companyA, 12345678”” represents the user ID and the identification number of the MA tag, respectively. The user ID may be hashed in consideration of security.

In description 11, “function (m,src)” is a definition of a function whose arguments are (m,src). In description 11, “src=https://example.com/hoge” indicates the current page and indicates which part of the company's HP is visited by the browsing person.

In description 12, “https://example/mts.js” is a library of JavaScript (registered trademark) posted to the public by the MA server 40. In this library, an address of the MA server 40 is defined, and a method (function) of “mt” is defined. The tag/form embedding unit 43 designates the library that is associated with the MA identification information in advance.

In description 13, among the parameters of mt(‘send’, ‘pageview’), “send” means transmitting information to the MA server 40, and “pageview” means that information to be transmitted is “PV.” When “mt” method is executed, the PV information is sent to the address of the MA server 40 that is registered in “https://example/mts.js” library in advance.

The transmission of the PV number from the HP posting server 60 to the MA server 40 is just one example, and the HP posting server 60 can transmit the “conversion” (CV) and the cookie to the MA server 40. Further, by using the cookie, the HP posting server 60 can determine whether the identity of the browsing person is the same or not and can count the number of viewing persons, and then transmit these information to the MA server 40. The conversion (CV) indicates an achievement of a purpose of HP, such as the number of inquiries and the number of material requests obtained in the “lead nurturing.”

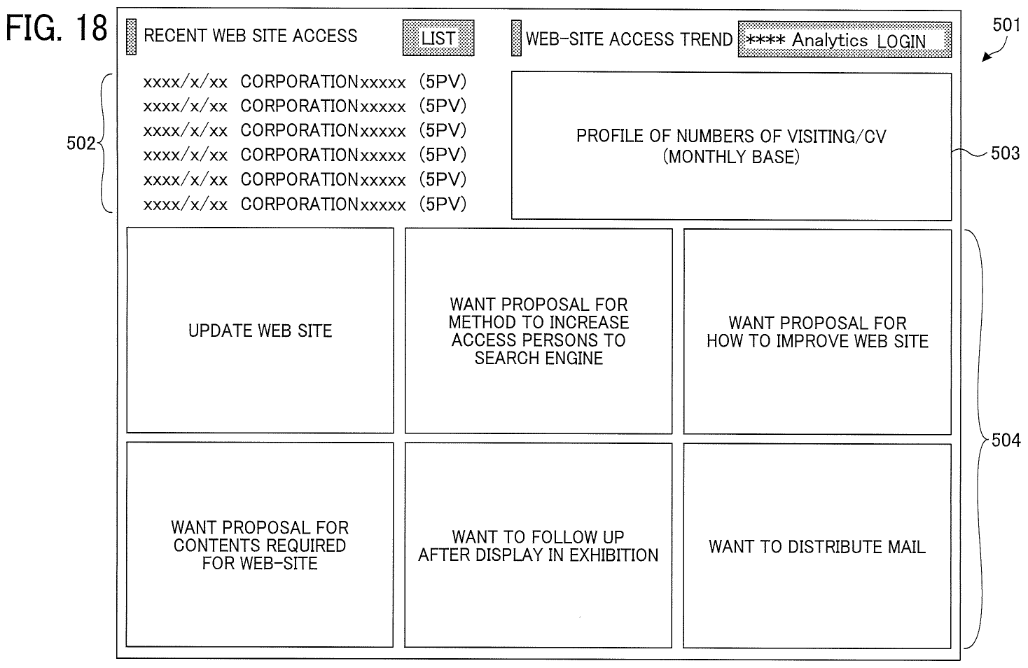

FIGS. 17A and 17B are examples of the browsing-related information that is transmitted by executing the MA tag. The browsing-related information of FIG. 17A is an example of information of page view (PV) number for one page of the HP of one day, posted by the HP posting server 60. In the browsing-related information of FIG. 17A, “uri”:https://example.com/hoge” represents a page on which the PV number was counted, “date”:“2018-06-12” represents the date on which the PV number count was counted, and “pv”:“3235” represents the PV number.

The browsing-related information of FIG. 17B is an example of information of PV number, the number of inquiries, and the CV number for the entire HP for six months. In the browsing-related information of FIG. 17B, “domain”:“example.com” represents an HP domain, “term”:“2018-01-01-2018-06-30” represents the period (six months), “pv”:“423514” represents the PV number, “contact”:“3453” represents the number of viewing persons of the HP, and “”cv“:”242″ represents the CV number (e.g., number of inquiries).

MA Information Viewed by User:

Hereinafter, a description is given of the MA information to be viewed by the user 9 with reference to FIG. 18. FIG. 18 is an example of an MA information screen 501 displayed on the display device 202 when the user terminal 13 communicates with the assistance server 50. The MA information screen 501 includes, for example, a web site access number field 502, a web site access trend field 503, and optional buttons 504.

The web site access number field 502 displays the company name of the company that has accessed HP recently. The page view (PV) is the number of times each company has visited the HP. The PV can be counted, for example, by the HP posting server 60 by transmitting the cookie to a browser of a browsing person. The web site access trend field 503 displays the number of viewing persons and the number of CV in a graph.

Various buttons corresponding to various service contents provided by the assistance server 50 are displayed as the optional buttons 504. The user 9 can perform, for example, updating of the HP from the optional buttons 504.

Procedure from Automatic Consulting to Browsing of MA Information:

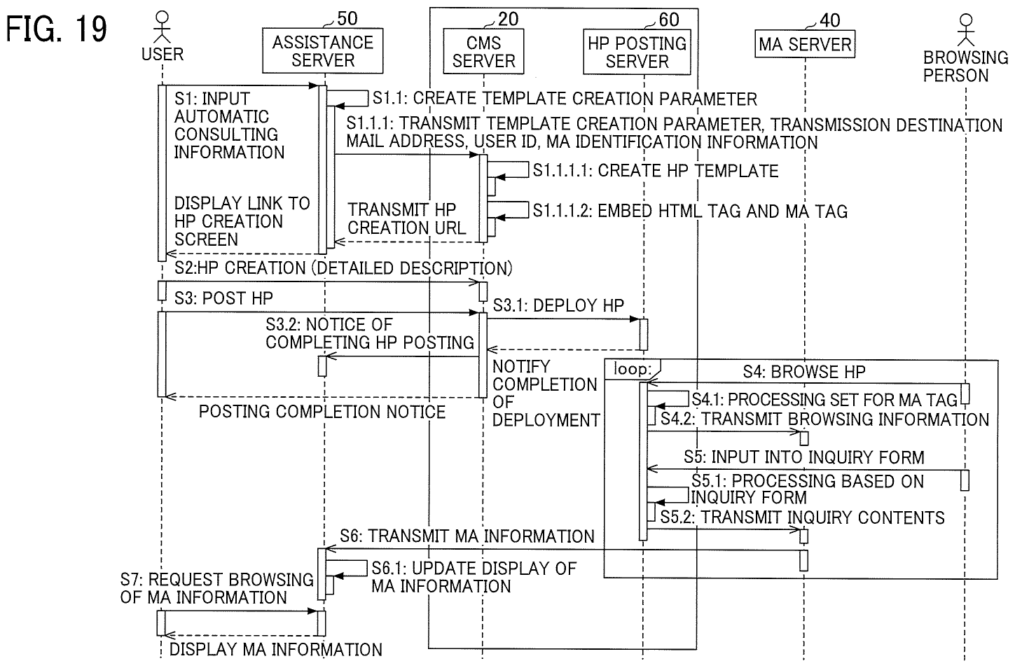

Hereinafter, a description is given of an example of a sequence diagram illustrating the procedure from the automatic consulting to the browsing (e.g., checking) of MA information with reference to FIG. 19.

S1: The user 9 operates the user terminal 13 to start a communication session with the assistance server 50. It is assumed that the user 9 logs in the assistance server 50 using a known login method, and the assistance server 50 recognizes the user ID as authenticated user ID. Then, the user terminal 13 displays the product characteristic input screen 301 (FIGS. 7A to 7D), or the business type selection screen 401 and the web-site type selection screen 411 (FIGS. 9A and 9B), and then the user 9 inputs the automatic consulting information via the screen. The operation reception unit 22 receives the input of the automatic consulting information, and then the first communication unit 21 transmits the automatic consulting information to the assistance server 50.

S1.1: The second communication unit 31 of the assistance server 50 receives the automatic consulting information, and then the consulting unit 33 refers to the parameter conversion DB 36 to create the HP template creation parameter. That is, the category of content is created.

S1.1.1: The third communication unit 32 of the assistance server 50 transmits the HP template creation parameter, the transmission destination mail address, the user ID and the MA identification information to the CMS server 20. The transmission destination information, the user ID and the MA identification information can be stored in the assistance server 50 in advance or can be input by the user 9. The third communication unit 32 in the assistance server 50 calls an API for embedding the HTML tag or MA tag from a number of APIs provided by the CMS server 20, to request the CMS server 20 to embed the HTML tag or MA tag. On the other hand, when the third communication unit 32 calls an API that does not embed the HTML tag or MA tag, the third communication unit 32 does not request the CMS server 20 to embed the HTML tag or MA tag.

S1.1.1.1: The fifth communication unit 41 of the CMS server 20 receives the HP template creation parameter, the transmission destination mail address, the user ID and the MA identification information from the assistance server 50. Then, the HP template creation unit 42 creates an HP template based on the HP template creation parameter. The HP template can be created in accordance with the number of content categories, but creating one HP may be sufficient.

S1.1.1.2: When the HP template creation unit 42 creates the HP template, the tag/form embedding unit 43 embeds, in the created HP template, the HTML tag to be used for transmitting the inquiry content to a company where the user 9 belongs to, and to the MA server 40. The HTML tag is described with reference to FIG. 15B. Further, the tag/form embedding unit 43 embeds the MA tag in the HP template. The MA tag is described with reference to FIG. 16.

When the HP template is created as above described, the HP template is stored in the HP storage unit 44 of the CMS server 20, and the fifth communication unit 41 of the CMS server 20 transmits the HP creation URL to the assistance server 50, in which the HP creation URL is the URL of HP template stored in the HP storage unit 44. The user ID can be sent to the assistance server 50 for identifying the user 9. Then, the assistance server 50 transmits the HP creation URL to the user terminal 13.

S2: Then, the user 9 can access the HP creation URL using the user terminal 13 to display the HP template on the user terminal 13 and complete the HP by inputting image and text on the HP template. The image and the text input by the user 9 are received by the operation reception unit 22 and set in the HP template, and then the first communication unit 21 transmits the completed HP to the CMS server 20. Then, the fifth communication unit 41 of the CMS server 20 receives the completed HP and saves the completed HP in the HP storage unit 44 of the assistance server 50. Then, the user may log-in the CMS server 20 again. However, it may be preferable that the DM system 100 uses the single sign-on, in which the user 9 can log in the CMS server 20 when the user 9 logs in the assistance server 50.

S3: Then, the user 9 performs a task or work for posting the HP. The work for posting the HP can be performed using known methods. The user 9 causes the user terminal 13 to communicate with the CMS server 20 and inputs an operation for posting the HP corresponding to the HP creation URL. The operation reception unit 22 of the user terminal 13 receives the operation for posting the HP, and then the first communication unit 21 of the user terminal 13 transmits the HP posting request to the CMS server 20. The user ID of the user 9 can be detected by the CMS server 20 by the single sign-on, or the user 9 can enter the user ID at this stage.

S3.1: The fifth communication unit 41 of the CMS server 20 receives the HP posting request, and then the CMS server 20 deploys the HP corresponding to the HP creation URL to the HP posting server 60. The deployment means that the HP (web site) is set in an accessible state. With this configuration, the HP can be viewed at the HP posting server 60. Then, the HP posting server 60 notifies the completion of the HP deployment to the fifth communication unit 41 of the CMS server 20.

S3.2: The fifth communication unit 41 of the CMS server 20 transmits a notice of completion of the HP posting to the assistance server 50 together with the user ID. Then, the fifth communication unit 41 registers the notice of completion of the HP posting in the user information DB 37 in association with the received user ID. Further, the fifth communication unit 41 of the CMS server 20 transmits the HP posting completion notice to the user terminal 13.

In steps S3 to S3.2, the HP posting request is sent to the CMS server 20 directly from the user terminal 13, but the user terminal 13 can be configured to transmit the HP posting request to the assistance server 50, in which it is assumed that the HP is managed or controlled by the user ID, and when the user terminal 13 transmits the user ID to the assistance server 50, the assistance server 50 transmits the HP posting request to the CMS server 20 by specifying the user ID.

S4: The browsing person operates the viewer terminal 14 to browse or see the HP.

S4.1: The MA tag embedded in the HP in the HP posting server 60 performs processing set for the MA tag. For example, the cookie is returned to count the number of visiting times to the HP and to determine if there is CV.

S4.2: The MA tag embedded in the HP in the HP posting server 60 is used to transmit the browsing-related information or browsing information and the user ID to the MA server 40 from the HP posting server 60. The MA information reception unit 52 of the MA server 40 receives these information, and the MA information management unit 53 of the MA server 40 processes the browsing-related information to calculate the PV number and the CV number per user (per company).

S5: The browsing person operates the viewer terminal 14 to enter or input the inquiry content into the inquiry form.

S5.1: The HTML tag embedded in the HP of the HP posting server 60 processes the inquiry content entered or input into the inquiry form by the browsing person that operates the viewer terminal 14 into a specific format, such as JavaScript object notation (JSON) format.

S5.2: The HTML tag embedded in the HP posted by the HP posting server 60 is used to transmit the inquiry content to the transmission destination mail address, such as transmitting the inquiry content and the user ID to the MA server 40. Then, the MA information reception unit 52 of the MA server 40 receives the inquiry content and the user ID, and the MA information management unit 53 of the MA server 40 manages or controls the inquiry content and the user ID in association with the user 9.

S6: The fourth communication unit 35 of the assistance server 50 periodically communicates with the MA server 40 to acquire the MA information by specifying each of the user 9 from the MA server 40. In this configuration, the fourth communication unit 35 of the assistance server 50 can be configured to transmit the last updated date and time performed for each of the user 9 to the MA server 40, with which, for example, the assistance server 50 can acquire the MA information corresponding to the difference between the most recent MA information, such as MA information at the time of the last update date and time, and current MA information, and thereby the communication processing load between the servers can be reduced. Further, the assistance server 50 can be configured to acquire the MA information associated with the user ID without specifying the user 9.

Further, it may be preferable that the fourth communication unit 35 of the assistance server 50 transmits the HP posting completion flag to the MA server 40 to notify that the posting of the HP has been completed. With this configuration, the MA server 40 can be prevented from detecting an error, such as no MA information exists because the HP is not yet posted.

In this example case, the sixth communication unit 51 of the MA server 40 transmits the MA information for each of the user 9 managed or controlled by the MA information management unit 53 to the assistance server 50. Further, the sixth communication unit 51 receives and accepts a request for MA information only if the HP posting completion flag is True. With this configuration, an occurrence of error, such as receiving a request for MA information related to the not-posted HP can be prevented. Further, when the fourth communication unit 35 of the assistance server 50 transmits the last update date and time of each of the user 9 to the MA server 40, the MA server 40 transmits the MA information, which is generated after the last update date and time, to the assistance server 50.

S6.1: When the fourth communication unit 35 of the assistance server 50 receives the MA information, the MA information providing unit 34 creates screen information, such as HTML, JavaScript (registered trademark) and CSS, used for displaying the MA information screen 501 (FIG. 18).

In step S6, the assistance server 50 requests the MA information to the MA server 40, but the MA server 40 can be configured to perform the PUSH transmission of the MA information to the assistance server 50, in which the MA server 40 may manage or control the last update date and time.

S7: The user 9 operates the user terminal 13 to start a communication session with the assistance server 50 and requests the assistance server 50 for browsing (e.g., checking) the MA information. The user 9 has been identified by the login operation. Then, the MA information providing unit 34 of the assistance server 50 transmits the MA information identified by the user ID to the user terminal 13. With this configuration, the first communication unit 21 of the user terminal 13 receives the screen information of the MA information screen 501, and the display control unit 23 can display the MA information screen 501.

As to the above described DM system 100, the assistance server 50 has an interface compatible to receive an input corresponding to the purpose of the user 9, with which the user 9 can use the automatic consulting processing via the assistance server 50 to create the HP template in accordance with the purpose of the user 9 and to coordinate the CMS tool and the MA tool. With this configuration, the user 9 can implement the desired measure using the digital marketing without selecting the CMS tool or MA tool and/or selecting the functions by the user 9 himself or herself. By accessing the assistance server 50, the user 9 can reduce a burden of operating the respective tools (e.g., CMS tool, MA tool) used for the digital marketing. For example, the user 9 is not required to directly implement the contents acquired from a (human) consultant using the CMS tool and MA tool.

Although the above embodiment has been described with reference to examples, the present invention is not limited to such embodiment, but various modifications and substitutions may be made within the scope of the present invention without departing from the scope of the present invention.

For example, as above described, the inquiry content is transmitted to the user 9 and the MA server 40, but the inquiry content can be transmitted to another relevant person. Further, the HP posting server 60 can be configured to transmit not only the inquiry content but also other information input by the browsing person to the user 9 and the MA server 40.

Further, in the above described embodiment, the user 9 can use the CMS server 20 and the MA server 40 via the assistance server 50, but the user terminal 13 can be configured to directly communicate with the CMS server 20 and the MA server 40, in which the user terminal 13 can receive the HP template creation parameter from the assistance server 50, transmit the HP template creation parameter to the CMS server 20, and acquire the browsing-related information from the MA server 40.

Further, if a plurality of assistance servers 50 exist, the functions of the assistance server 50 can be distributed across the plurality of servers.

Further, the example configuration of FIG. 6 is divided in accordance with the main functions in order to facilitate understanding of the processing by the assistance server 50, the CMS server 20, and the MA server 40, but the present invention is not restricted by the dividing pattern and the name of the processing units. The processing of the assistance server 50, the CMS server 20, and the MA server 40 can be divided into more processing units in accordance with the processing contents. Further, the processing of the assistance server 50, the CMS server 20, and the MA server 40 can be divided by integrating a plurality of processing in one processing unit.

Further, the second communication unit 31 is an example of a first reception unit, the consulting unit 33 is an example of a creation unit, the fourth communication unit 35 is an example of a second reception unit, the MA information providing unit 34 is an example of a providing unit, the third communication unit 32 is an example of a transmission unit, the HP template creation unit 42 is an example of a template creation unit, and the tag/form embedding unit 43 is an example of an embedding unit.

The above described digital marketing system can assist users to use each one of tools used for the digital marketing.

Each of the embodiments described above is presented as an example, and it is not intended to limit the scope of the present disclosure. Numerous additional modifications and variations are possible in light of the above teachings. It is therefore to be understood that, within the scope of the appended claims, the disclosure of this specification can be practiced otherwise than as specifically described herein. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A digital marketing system including a first service for performing a lead generation for attracting potential customers, and a second service for performing a lead nurturing for turning the potential customers into prospective customers, the digital marketing system comprising:
an information processing apparatus including circuitry, communicable with the first service and the second service via a network, the circuitry configured to
receive information on a purpose of digital marketing from a user terminal operated by a user, via the network;
instruct the first service to create a home page based on the information on the purpose of digital marketing;
receive, from the second service, marketing information applicable for marketing, the second service being configured to acquire the marketing information from the home page in response to browsing of the home page; and
provide the marketing information to the user terminal.

2. The digital marketing system according to claim 1,
wherein the circuitry of the information processing apparatus is configured to display, on a display of the user terminal, information assisting the user to input the information on the purpose of digital marketing, and receive the information on the purpose of digital marketing input to the user terminal, from the user terminal.

3. The digital marketing system according to claim 1,
wherein the information on the purpose of digital marketing includes one or more pieces of information on genre of product, information on a target business type expected to purchase product, selectable from one or more goods and one or more services, information on attribute of a target expected to purchase the product, and information on characteristics of the product,
wherein the circuitry of the information processing apparatus creates content information to be posted on the home page based on the one or more pieces of information on the genre, the target business type, the attribute of the target, and the characteristics of the product selected by the user.

4. The digital marketing system according to claim 1,
wherein the information on the purpose of digital marketing includes information on a business type of product, selectable from one or more goods and one or more services, and information on a type of web site to be posted on the home page collectively as content information,
wherein, in response to a selection of specific information on the business type of product and specific information on the type of web site by the user, the circuitry of the information processing apparatus converts the specific information on the business type of product into a first score and the specific information on the type of web site into a second score, and creates the specific information on the business type of product having the first score and the specific information on the type of web site having the second score as the content information to be posted on the home page, in which the specific information on the business type of product and the specific information on the type of web site are posted on the home page in a descending order of scores determined by comparing the first score and the second score.

5. The digital marketing system according to claim 3,
wherein the circuitry of the information processing apparatus transmits, to the first service, the created content information as the information on the purpose of digital marketing together with identification information of the second service,
wherein the first service creates a template used for creating the home page based on the created content information, and embeds, into the template used for creating the home page, a first tag to be used to transmit browsing-related information indicating a browsing history of the home page to the second service, together with the identification information of the second service.

6. The digital marketing system according to claim 5,
wherein the first service sets an inquiry form in the template used for creating the home page, and embeds, in the template, a second tag to be used to transmit an inquiry content input in the inquiry form set on the home page when an input operation is performed on the home page, to the second service, together with the identification information of the second service.

7. The digital marketing system according to claim 6,
wherein the circuitry of the information processing apparatus transmits, to the first service, the created content information, the identification information of the second service and transmission destination information corresponding to the user terminal,
wherein the first service embeds, into the second tag, the transmission destination information to be used for transmitting the inquiry content, input in the inquiry form set on the home page, to the user terminal.

8. The digital marketing system according to claim 6,
wherein the circuitry of the information processing apparatus transmits, to the first service, the created content information, the identification information of the second service and identification information of the user terminal,
wherein the first service sets, in the first tag and the second tag, the identification information of the user terminal to be transmitted to the second service together with the browsing-related information and the inquiry content input in the inquiry form.

9. The digital marketing system according to claim 7,
wherein the circuitry of the information processing apparatus transmits, to the first service, the created content information, the identification information of the second service and identification information of the user terminal,
wherein the first service sets, in the first tag and the second tag, the identification information of the user terminal to be transmitted to the second service together with the browsing-related information and the inquiry content input in the inquiry form.

10. The digital marketing system according to claim 4,
wherein the circuitry of the information processing apparatus transmits, to the first service, the created content information as the information on the purpose of digital marketing together with identification information of the second service,
wherein the first service creates a template used for creating the home page based on the created content information, and embeds, into the template used for creating the home page, a first tag to be used to transmit browsing-related information indicating a browsing history of the home page to the second service, together with the identification information of the second service.

11. The digital marketing system according to claim 10,
wherein the first service sets an inquiry form in the template used for creating the home page, and embeds, in the template, a second tag to be used to transmit an inquiry content input in the inquiry form set on the home page when an input operation is performed on the home page, to the second service, together with the identification information of the second service.

12. The digital marketing system according to claim 11,
wherein the circuitry of the information processing apparatus transmits, to the first service, the created content information, the identification information of the second service and transmission destination information corresponding to the user terminal,
wherein the first service embeds, into the second tag, the transmission destination information to be used for transmitting the inquiry content, input in the inquiry form set on the home page, to the user terminal.

13. The digital marketing system according to claim 11,
wherein the circuitry of the information processing apparatus transmits, to the first service, the created content information, the identification information of the second service and identification information of the user terminal,
wherein the first service sets, in the first tag and the second tag, the identification information of the user terminal to be transmitted to the second service together with the browsing-related information and the inquiry content input in the inquiry form.

14. The digital marketing system according to claim 12,
wherein the circuitry of the information processing apparatus transmits, to the first service, the created content information, the identification information of the second service and identification information of the user terminal,
wherein the first service sets, in the first tag and the second tag, the identification information of the user terminal to be transmitted to the second service together with the browsing-related information and the inquiry content input in the inquiry form.

15. An information processing apparatus communicable with a first service for performing a lead generation for attracting potential customers, and a second service for performing a lead nurturing for turning the potential customers into prospective customers via a network, the information processing apparatus comprising circuitry configured to:
receive information on a purpose of digital marketing from a user terminal operated by a user, connected to the information processing apparatus via the network;
instruct the first service to create a home page based on the information on the purpose of digital marketing;
receive, from the second service, marketing information applicable for marketing, the second service being configured to acquire the marketing information from the home page in response to browsing of the home page; and
provide the marketing information to the user terminal.

16. A method of assisting digital marketing using an information processing apparatus communicable with a first service for performing a lead generation for attracting potential customers, and a second service for performing a lead nurturing for turning the potential customers into prospective customers via a network, the method comprising:
receiving information on a purpose of digital marketing from a user terminal operated by a user, connected to the information processing apparatus via the network;
instructing the first service to create a home page based on the information on the purpose of digital marketing;
receiving, from the second service, marketing information applicable for marketing, the second service being configured to acquire the marketing information from the home page in response to browsing of the home page; and
providing the marketing information to the user terminal.
